(19) United States
(12) Patent Application Publication
(10) Pub. No.: US 2019/0046986 A1
(43) Pub. Date: Feb. 14, 2019

(54) FIBER MICROFLUIDICS

(71) Applicant: MASSACHUSETTS INSTITUTE OF TECHNOLOGY, Cambridge, MA (US)

(72) Inventors: Rodger YUAN, Boston, MA (US); Jaemyon LEE, Cambridge, MA (US); Joel VOLDMAN, Belmont, MA (US); Yoel FINK, Cambridge, MA (US); Hao-wei SU, Cambridge, MA (US)

(73) Assignee: MASSACHUSETTS INSTITUTE OF TECHNOLOGY, Cambridge, MA (US)

(21) Appl. No.: 16/152,774

(22) Filed: Oct. 5, 2018

Related U.S. Application Data
(63) Continuation of application No. PCT/US17/55000, filed on Oct. 3, 2017.
(60) Provisional application No. 62/404,183, filed on Oct. 4, 2016.

(51) Int. Cl. B01L 3/00; B03C 5/00; B03C 5/02; G01N 27/447

(52) U.S. Cl. CPC B01L 3/502761; B03C 5/005; B03C 5/026; B01L 2400/0424; B01L 2200/0652; B01L 2300/0864; B01L 2300/08; G01N 27/44791

(57) ABSTRACT

A particle separation device can include a fiber microfludic structure.

### CLAIM FOR PRIORITY

This application claims priority to U.S. Provisional Patent Application Ser. No. 62/404,183, filed on Oct. 4, 2016, each of which is hereby incorporated by reference in its entirety.

### FEDERAL SPONSORSHIP STATEMENT

This invention was made with Government support under Grant Nos. DMR-0819762, and DMR-1419807 awarded by the National Science Foundation and under Grant No. U24 AI118656 awarded by the National Institutes of Health and under Grant No. N66001-11-1-4182 awarded by the Space and Naval Warfare Systems Center and under Contract No. W911NF-13-D-0001 awarded by the Army Research Office. The Government has certain rights in the invention.

### TECHNICAL FIELD

This invention relates to microfluidic structures and methods of use.

### BACKGROUND

Over the past few decades, microfluidics has become an established platform for the development of new methods and devices in the life sciences and chemistry. See, for example, Beebe, D. J., Mensing, G. a & Walker, G. M. Physics and applications of microfluidics in biology. Annu. Rev. Biomed. Eng. 4, 261-286 (2002); Mark, D., Haeberle, S., Roth, G., von Stetten, F. & Zengerle, R. Microfluidic lab-on-a-chip platforms: requirements, characteristics and applications. Chem. Soc. Rev. 39, 1153-82 (2010); Elvira, K. S., Casadevall i Solvas, X., Wootton, R. C. R. & de Mello, A. J. The past, present and potential for microfluidic reactor technology in chemical synthesis. Nat. Chem. 5, 905-15 (2013); Nguyen, N. T. & Wereley, S. Fundamentals and applications of microfluidics. (Artech House, 2006); and Dittrich, P. S. & Manz, A. Lab-on-a-chip: microfluidics in drug discovery. Nat. Rev. Drug Discov. 5, 210-218 (2006).

### SUMMARY

In one aspect, a particle separation device can include a fiber microfluidic structure, a fluid input, and an outlet.

In another aspect, a method of manufacturing a fiber microfluidic structure can include drawing a preform into a fiber, the fiber having a channel with a cross-section of a preselected shape.

In another aspect, a method of cell separation can include passing fluid containing a plurality of cells through a fiber microfluidic structure, and collecting a plurality of outputs from an opening of the fiber microfluidic structure. In certain circumstances, the method can include applying a voltage across a width of the fiber structure.

In certain circumstances, the fiber microfluidic structure can have at least one concave feature in a cross-section of the structure. For example, the cross-section can be a star or a cross.

In certain circumstances, the fiber microfluidic structure can have a length that is at least three times the width of a channel of the fiber.

In certain circumstances, the outlet can include a plurality of fluid outlets. For example, two, three, four, or five streams can be separated and exit from the outlet.

In certain circumstances, the structure can include electrodes arranged to apply a voltage across a width of the fiber structure.

Other aspects, embodiments, and features will be apparent from the following description, the drawings, and the claims.

### BRIEF DESCRIPTION OF THE DRAWINGS

FIG. 1 (panels a-d) depict a fiber microfluidic platform for particle manipulation. Panel (a) represents a schematic of the thermal drawing process showing a preform being fed through the hot zone (yellow ring) and drawn into a fiber. The fiber cross-section (inset) matches that of the preform. Panel (b) represents that particles enter the microfluidic fiber channels, which can be geometrically tunable (left) or multimaterial (right), in a random distribution. Panel (c) represents that particles are subjected to transverse forces induced within the fiber via passive (inertial focusing, left) or active (dielectrophoresis, right) mechanisms. Panel (d) represents that at the fiber outlet, particles reach their equilibrium positions.

FIG. 2 (panels a-c) depict a schematic of a complete cell separation fiber device with fiber-to-world (FTW) connection. Panel (a) depicts two types of particles enter the device at the fiber inlet in a random distribution. Panel (b) depicts that particles are spatially separated within the fiber channels by transverse forces. In this case, green particles are partitioned to the outer two thirds of the channel, while red particles are guided to the center third of the channel. Panel (c) depicts that laminar flow is maintained at the fiber-FTW interface, allowing unlike particles to be physically separated by a stream-splitting trifurcation fork.

FIGS. 3A-3D depict equilateral cross and star-shaped fiber fabrication and characterization. FIG. 3A represents photographs of the preform cross-section (left) and the drawn preform, showing the transition section from preform to fiber (center), of the equilateral cross fiber. (Right) A drawn fiber is wrapped around a mandrel to demonstrate its mechanical robustness. FIG. 3B represents a schematic of the experimental setup for microscopy (top). (Bottom) Image of a microfluidic fiber that has been interfaced to microfluidic tubing. FIGS. 3C-3D represent inertial focusing characterization of a FIG. 3C equilateral cross channel and FIG. 3D star-shaped channel. (Left) Cross sectional images of the fiber channels. LEF images of particle focusing for a range of Rₚ are analyzed to obtain intensity profiles (center left) which, through symmetry, are used to deduce the complete set of focusing positions along the cross-section (center right). Confocal imaging (right) is used to verify the equilibrium positions.

FIGS. 4A-4F represent numerical modelling of inertial focusing fibers. FIG. 4A depicts a schematic showing the long axis and short axis of a unit cell for the (top) equilateral cross fiber and (bottom) star-shaped fiber. FIGS. 4B-4C represent a vector plot of numerically computed inertial lift forces along a symmetric section of the channel cross-section for the (b) equilateral cross fiber (Rₚ=0.66) and (c) the star-shaped fiber (Rₚ=2.3). Unstable (dotted) and stable (solid) equilibrium positions are indicated by red circles. FIGS. 4D-4E represent plots of the fluid velocity magnitude (left) and shear gradient magnitude (right) vs. normalized arc length are shown along the LA (green) and SA (blue). FIG. 4F represents numerically computed velocity magnitude for the (left) equilateral cross fiber and (right) star-shaped fiber, plotted in greyscale with increasing tint corresponding to increasing velocity, starting from white (velocity=0) to black (maximum velocity).

FIGS. 5A-5E depict DEP fiber design and characterization. FIG. 5A shows a schematic of the cross-sectional design of the DEP fiber. The cladding is polycarbonate (grey) while the electrodes are conductive polyethylene (black) and eutectic BiSn alloy (white). FIG. 5B represents numerically computed electric field strength within the fiber channel under an applied voltage of 25V. FIG. 5C represents a vector plot of the DEP force direction along the fiber cross-section. The electric field gradient will guide nDEP particles (green) to the outer two-thirds of the channel (separated by pink lines) and pDEP particles (red) to the center third of the channel. FIG. 5D represents a cross-sectional image of the DEP fiber. FIG. 5E represents LEF streaks of the particle behavior of BA/F3 (red) and polystyrene beads (green) were processed into intensity profiles to show particle distributions within the fiber channel under different applied voltages.

FIGS. 6A-6E depict DEP fiber cell separation device design and characterization. FIG. 6A represents an image of a fully assembled DEP fiber cell separation device. FIG. 6B represents an image of a 3D-printed FTW connector showing the three sections of the chip: 1) the self-aligning mating port, 2) the stream splitting trifurcation fork, and 3) the parallel channel section. FIG. 6C is a microscope image of the self-aligning mating port and the fiber-FTW interface with the interior channels highlighted (light blue lines). FIG. 6D shows LEF streaks of polystyrene beads (green) and BA/F3 cells (red) flowing through the trifurcation fork under a 15 V applied voltage. FIG. 6E shows intensity profiles within the parallel channel region showing the polystyrene bead (green) and BA/F3 cell (red) distributions in each outlet channel for a range of applied voltages.

FIG. 7 represents an impedance profile of DEP microfluidic channel filled with different media.

### DETAILED DESCRIPTION

The need to make the precise, geometrically constrained features necessary to exploit the benefits of miniaturization is non-trivial; consequently, the emergence of microfluidics has been catalyzed by the development of silicon microfabrication and soft lithography techniques adapted from the microelectronics industry. While these techniques are immensely powerful, they are planar processes mostly limited to creating two-dimensional extruded features. Many compelling opportunities in microfluidic design have remained unexplored due to limitations in cross-sectional design freedom imposed by planar fabrication methods, such as restricted control of channel geometry and multimaterial feature placement. For example, while it has been shown that utilization of non-rectangular channels can enhance microfluidic device performance, geometric design optimization beyond simple geometries (i.e. triangles, trapezoids, semi-circles) is inaccessible using planar fabrication methods. See, Park, J. et al. Simple haptotactic gradient generation within a triangular microfluidic channel. Lab Chip 10, 2130-2138 (2010); Cheng, I.-F. et al. Antibody-free isolation of rare cancer cells from blood based on 3D lateral dielectrophoresis. Lab Chip 15, 2950-2959 (2015); and Wu, L., Guan, G., Hou, H. W., Bhagat, A. A. S. & Han, J. Separation of leukocytes from blood using spiral channel with trapezoid cross-section. Anal. Chem. 84, 9324-9331 (2012). In addition, the spatial positioning of multimaterial elements around the channel cross-section, such as conductive electrodes, is a key design consideration in many microfluidic applications that microfluidic designers lack complete control over due to the limitations of traditional fabrication techniques. See, Yan, S. et al. On-chip high-throughput manipulation of particles in a dielectrophoresis-active hydrophoretic focuser. Sci Rep 4, 5060 (2014); Voldman, J. Electrical forces for microscale cell manipulation. Annu. Rev. Biomed. Eng. 8, 425-454 (2006); and Vahey, M. D. & Voldman, J. An Equilibrium Method for Continuous-Flow Cell Sorting Using Dielectrophoresis. Anal. Chem. 80, 3135-3143 (2008).

A new microfluidic fabrication platform is introduced, fiber microfluidics, that circumvents limitations of planar processes by leveraging dimensional reduction to create complex microchannels. The utility of the fiber microfluidics system is presented in the context of particle manipulation and separation. First, cross-shaped and star-shaped microchannels have been fabricated to study the effects of concave geometric features on inertial particle focusing in straight channels. Second, conductive materials can be introduced onto fiber channel surfaces to create a dielectrophoretic (DEP) particle manipulation fiber that, in conjunction with a 3D printed self-aligning fiber-to-world connection, can separate cells at high-throughput.

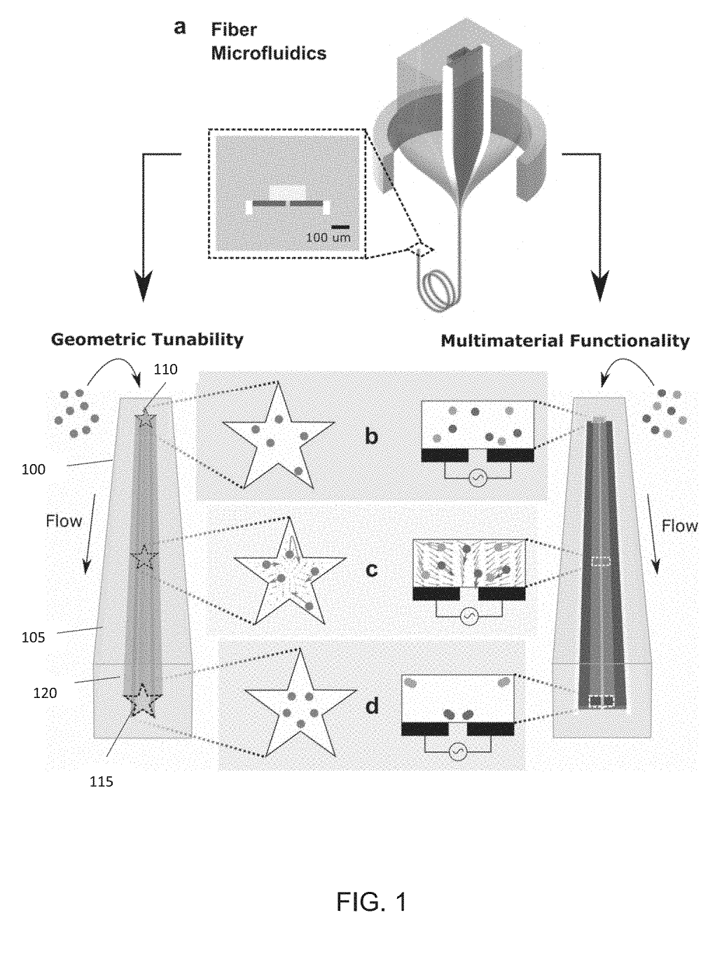

A particle separation device can include a fiber microfluidic structure, a fluid input, and an outlet. Referring to FIG. 1, the device 100 can include a fiber microfluidic structure 105, a fluid input 110 and an outlet 115, which can be connected by a channel 120. The microfluidic structure can be drawn from a preform having a channel with a cross-section of a preselected shape. The preform can be a polymer, such as a polycarbonate, a polyolefin, or a polyester. The fiber microfluidic structure can have at least one concave feature in a cross-section of the structure. For example, the cross-section can be a star or a cross. When a fluid containing particles flow through the structure having the concave feature, the particles can be manipulated by the flow and surface geometry to create regions of different particles. Other forces, such as electric or magnetic fields can be applied to supplement the forces created by the flow.

For example, a method of cell separation can include passing fluid containing a plurality of cells through a fiber microfluidic structure, and collecting a plurality of outputs from an opening of the fiber microfluidic structure. In some examples, the method can include applying a voltage across a width of the fiber structure.

The width of the microfluidic structure, or a channel within the structure, can be less than a millimeter, for example, 1 to 1,000 microns, less than 750 microns, less than 500 microns or less than 250 microns, for example, 125 microns.

In certain circumstances, the fiber microfluidic structure can have a length that is at least three times the width of a channel of the fiber.

### Results

### Fiber Microfluidics Platform

The basis of fiber microfluidics is the thermal fiber drawing technique, in which a scaled up version of the fiber (i.e., the preform) is heated and drawn, resulting in cross-sectional reduction while maintaining cross-sectional geometry (FIG. 1, panel a). Using this technique, microchannels and structural features with length-scales as small as <50 μm have been readily produced with a wide range of materials, such as optically clear plastics, conductive materials, and piezoelectric materials. See, Canales, A. et al. Multifunctional fibers for simultaneous optical, electrical and chemical interrogation of neural circuits in vivo. Nat. Biotechnol. 33, (2015); and Egusa, S. et al. Multimaterial piezoelectric fibres. Nat. Mater. 9, 643-648 (2010).

The fiber microfluidic platform has two primary advantages over the traditional photolithographic approach: (a) Arbitrary design of the geometric shape of the microchannel cross-section, or geometric cross-sectional tunability, and (b) arbitrary design of material arrangement around the microchannel cross-section, or multimaterial functionality. (FIG. 1 panels b-d).

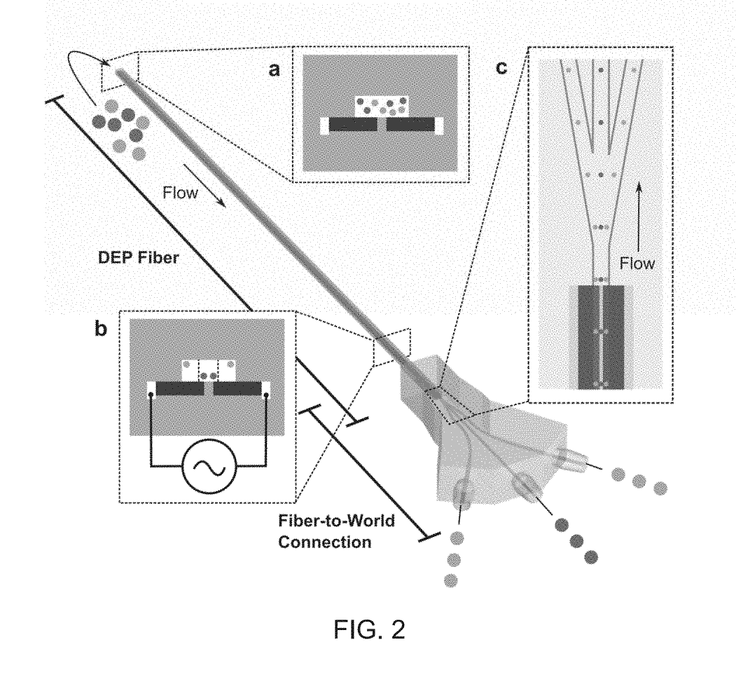

For a continuous cell separation device to be useful, cell populations must be physically separated at the outlet, which means splitting the flow from the fiber into multiple outlets. Since it is difficult to split the fibers themselves, fiber-to-world connectors (FTW) can be designed that can mate with the fibers at the outlet and can transition the flow from the fiber into multiple outlets (FIG. 2, panels a-c).

### Geometric Cross-Sectional Tunability: Inertial Microfluidics

First, geometric cross-sectional tunability can be used to probe new regimes in inertial microfluidics. Inertial microfluidics is the study of microparticle focusing and separation in laminar flow regimes which require the inclusion of the inertial terms in the Navier-Stokes equation to accurately describe particle behavior. In straight, rectangular channels, particles have been found to migrate to predictable equilibrium positions on the channel cross-section, which have been used as passive methods for high-throughput particle focusing and separation. See, Di Carlo, D., Edd, J. F., Humphry, K. J., Stone, H. a. & Toner, M. Particle segregation and dynamics in confined flows. Phys. Rev. Lett. 102, 1-4 (2009); Liu, C., Hu, G., Jiang, X. & Sun, J. Inertial focusing of spherical particles in rectangular microchannels over a wide range of Reynolds numbers. Lab Chip 15, 1168-1177 (2015); Bhagat, A. A. S., Kuntaegowdanahalli, S. S., Kaval, N., Seliskar, C. J. & Papautsky, I. Inertial microfluidics for sheath-less high-throughput flow cytometry. Biomed. Microdevices 12, 187-195 (2010); Hur, S. C., Tse, H. T. K. & Di Carlo, D. Sheathless inertial cell ordering for extreme throughput flow cytometry. Lab Chip 10, 274-280 (2010); Tanaka, T. et al. Separation of cancer cells from a red blood cell suspension using inertial force. Lab Chip 12, 4336 (2012); and Tanaka, T. et al. Inertial migration of cancer cells in blood flow in microchannels. Biomed. Microdevices 14, 25-33 (2012). While the spatial location of inertial focusing positions in primary flows is highly dependent on its cross-sectional geometry, fabrication challenges have limited experimental study to only simple shapes (rectangles, circles, triangles). See, Di Carlo, D., Edd, J. F., Humphry, K. J., Stone, H. a. & Toner, M. Particle segregation and dynamics in confined flows. Phys. Rev. Lett. 102, 1-4 (2009); Gossett, D. R. et al. Inertial Manipulation and Transfer of Microparticles Across Laminar Fluid Streams. Small 8, 2757-2764 (2012); Segre, G. & Silberberg, A. Behaviour of macroscopic rigid spheres in Poiseuille flow. J. Fluid Mech. 14, 115-135 (1962); and Kim, J. et al. Inertial Focusing in Non-rectangular Cross-section Microchannels and Manipulation of Accessible Focusing Position. Lab Chip 16, (2016). Thus, applications that utilize primary inertial forces are designed with limited control over the spatial location of focusing positions along the cross-section. The fiber microfluidics platform enables the fabrication of microchannels with arbitrary cross-sectional shape, enabling new degrees of freedom in the design of inertial microfluidic channels and devices.

Inertial Migration of Particles in Channels with Concave Geometric Features

Microfluidic fibers were fabricated with equilateral cross-shaped and star-shaped microchannel geometries to study the effect of concave channel features on the stable equilibrium positions of particles in inertial flow. Furthermore, the five-pointed star channel also serves to highlight the geometric cross-sectional tunability of the fiber microfluidics platform; fabrication of such a microchannel has not been demonstrated using traditional microfabrication approaches.

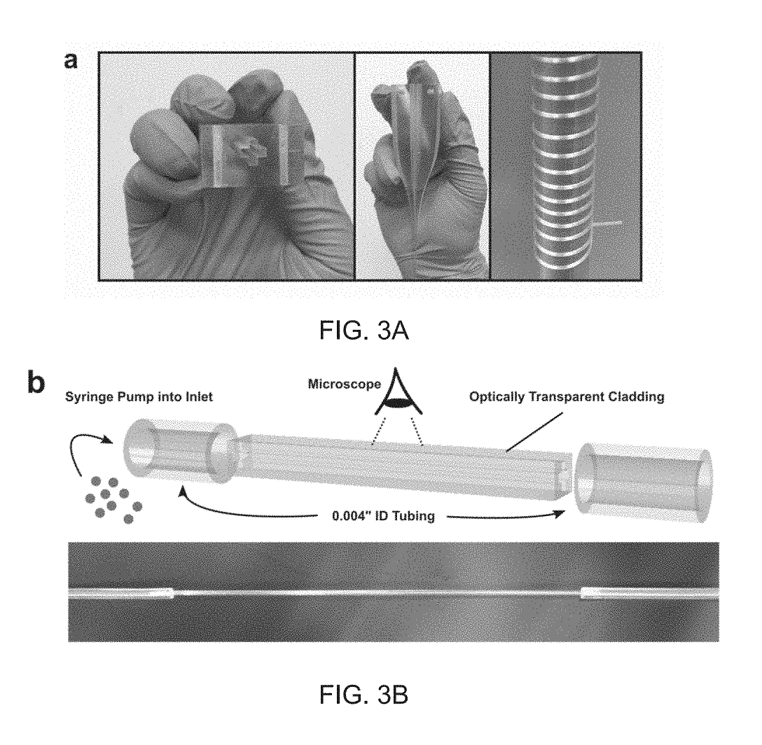

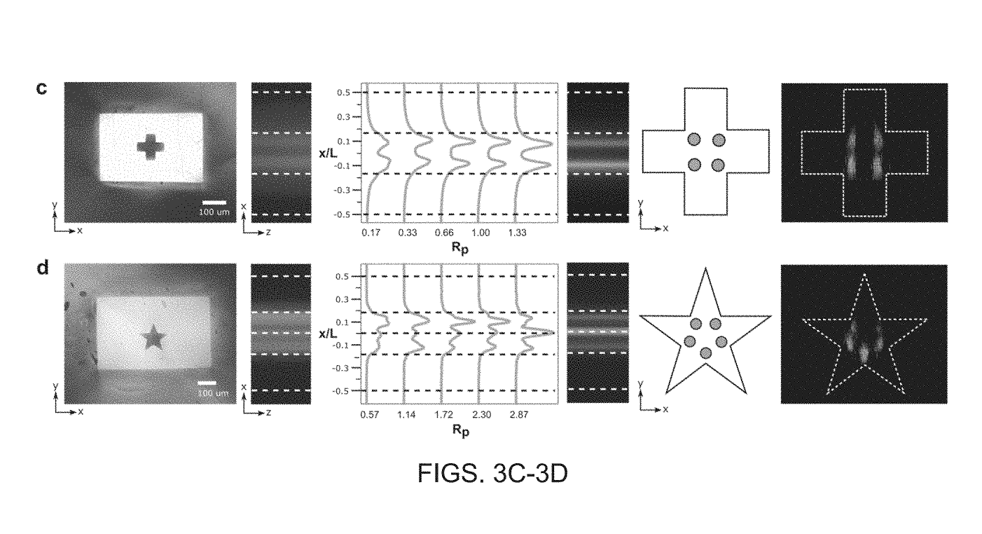

Fibers were fabricated by drawing a preform with a hollow core geometry corresponding to the desired microchannel shape into ˜100 meters of flexible fiber such that the cross-sectional fiber dimensions were reduced by a factor of ˜40 (FIG. 3A). To enable visualization of the channel interior, optically transparent polycarbonate was chosen as the cladding material. The microfluidic fibers are easily interfaced to external components using microfluidic tubing (FIG. 3B).

Particle distributions within the fibers were observed for 10 μm polystyrene beads suspended in water using long exposure fluorescence (LEF) over a range of particle Reynolds numbers (Rₚ, defined as Rₚ=Re(a/H)²=ρUa²/μH, where ρ is the fluid density, U is the maximum fluid velocity, a is the particle diameter, μ is the fluid viscosity, and H is the hydraulic diameter of the channel). Confocal microscopy experiments were performed to validate the use of symmetry to deduce the spatial positions of obstructed inertial focusing points from the two-dimensional LEM results.

An equilateral cross-shaped channel was fabricated (FIG. 3C) with four concave right-angled corners. The total length and width of the cross measured 125 μm. Focusing positions of particles flowing through the channel were observed from the −y direction. The long exposure fluorescence streaks (FIG. 3C, center left) show that inertial lift forces are significant in flows of particle Reynolds numbers as low as 0.17, where particles are weakly focused into two streaks along the center third of the cross. This is in agreement with previous studies of inertial migration in fully convex channel geometries. See, Liu, C., Hu, G., Jiang, X. & Sun, J. Inertial focusing of spherical particles in rectangular microchannels over a wide range of Reynolds numbers. Lab Chip 15, 1168-1177 (2015). Furthermore, as is expected with inertial focusing, as the flow rate, and thereby the particle Reynolds number of the flow, increases, peaks become sharper as particles are more strongly focused into their equilibrium positions.

By taking advantage of symmetries in the channel geometry, the LEF images led to the deduction that there are four equilibrium migration positions along the channel cross section (FIG. 3C, center right); two are represented by the two streaks present in the LEF image and the other two are directly beneath them in the −y direction, obstructed from view. This was confirmed by imaging the x-y plane of the microchannel using fluorescence confocal microscopy (FIG. 3C, right), which also shows four distinct equilibrium positions in agreement with those predicted from LEF.

The influence of concave geometric features was further studied on inertial focusing positions using a five-pointed star channel (FIG. 3D, left). The distance between opposite points of the star channel was 150 μm. Particles were observed in the +y direction.

The LEF images (FIG. 3d, center left) from the star channel show that particles migrate to three streaks at the center of the channel that sharpen as the particle Reynolds number increases. From the five-fold symmetry of the star shape, it can be deduced that there are five inertial focusing positions for the star geometry which, similar to those of the equilateral cross, are located adjacent to each of the five concave corners of the star (FIG. 3D, center right). When Rₚ reaches 2.87, additional shoulder peaks emerge along the inner sides of the outer streaks. These peaks represent the upper two equilibrium positions shown at the center right of FIG. 2D, which are overlapped into a single streak at lower Rₚ where the inertial lift forces are weaker. Confocal microscopy of the x-y plane (FIG. 3D, right) confirmed the positions the five equilibrium points.

### Mechanisms of Particle Migration

The particle focusing behavior of the equilateral cross channel and the star channel show equilibrium positions that are adjacent to the concave corners in the channel geometry. This behavior is qualitatively in contrast to the convex channel geometries traditionally studied in inertial microfluidics, such as rectangles or triangles, in which particles tend to focus at positions adjacent to a straight channel face.

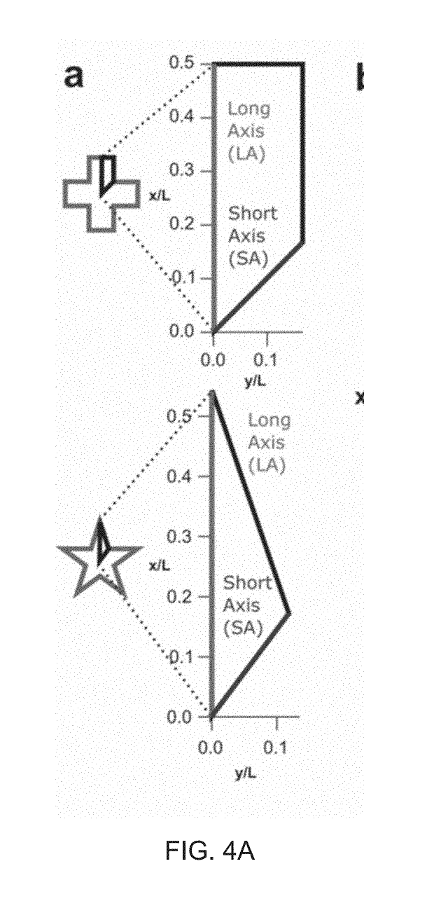

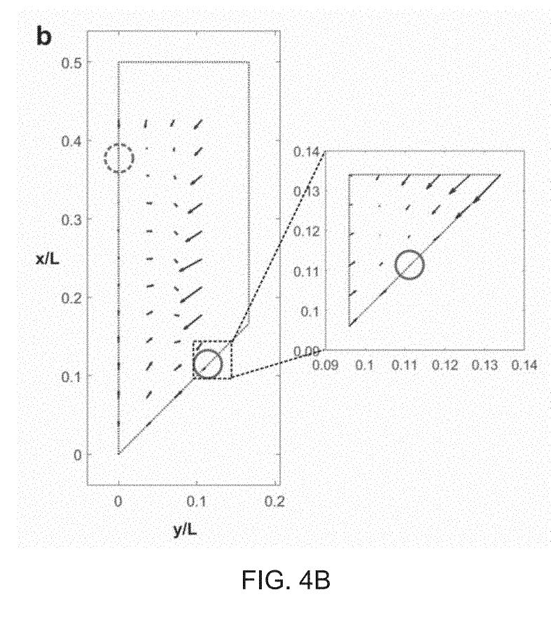

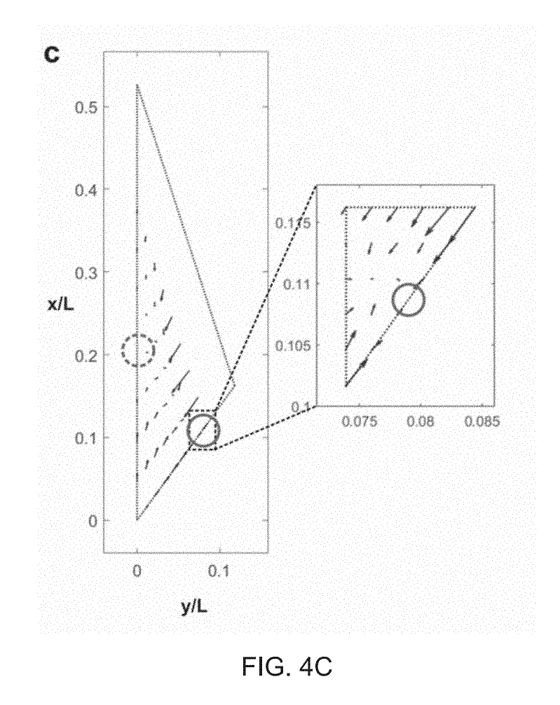

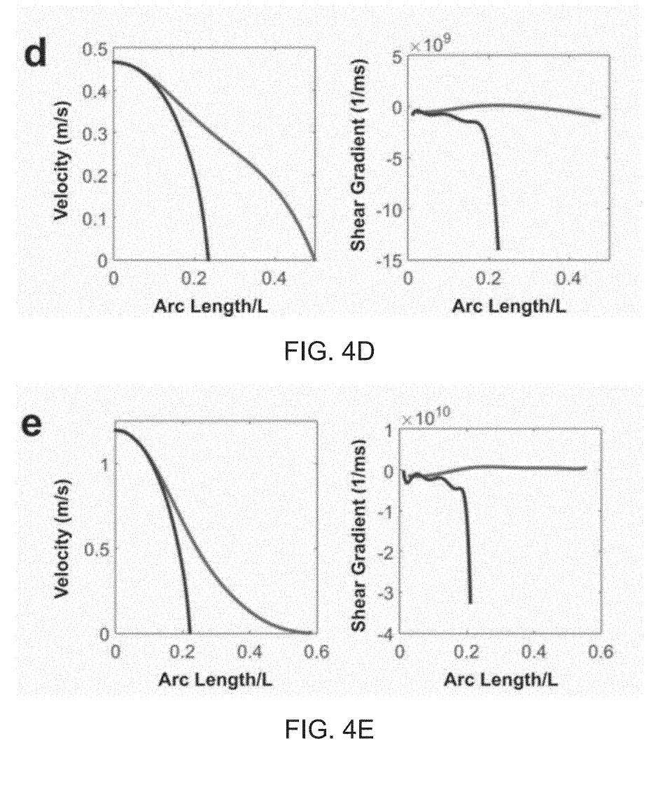

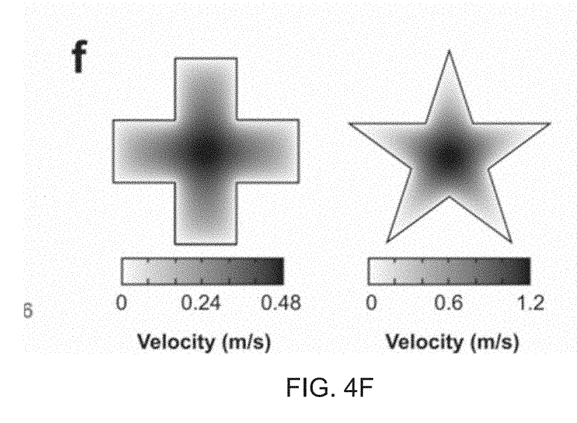

To explain this, numerical modelling was used to calculate the inertial lift forces along the cross-section of each microchannel (FIG. 4A). In the force plots for both the equilateral cross and star, there exist two equilibrium points; one stable position near the concave corner along the short axis (SA, blue line) that runs from the channel center to a concave corner and one unstable position far from the center along the long axis (LA, green line) that runs from the channel center to the midpoint of an extremity.

The inertial force plots of the equilateral cross and star channels show two general trends:

1) particles moving along the LA in the +y direction are drawn away from the channel center and
2) particles off of the LA are guided in a two-step process in which they first move away from the channel center in the +x-direction and then in the −y direction until they reach the stable equilibrium position.

While the focusing behavior of the equilateral cross and star channels is unique, the effect of concave geometric features on inertial equilibrium positions is consistent with the prevailing knowledge on inertial particle migration. Inertial lift is dominated by two opposing forces: the shear-gradient lift force, which acts in the opposite direction of the shear gradient and typically directs particles to walls, and the wall-induced lift force, which directs particles away from the channel walls. Equilibrium points arise when the sum of these two forces are equal from all directions.

The focusing behavior of the equilateral cross and star channel is caused by a high shear-gradient lift force along the SA relative to that of the long LA. It is widely accepted that the shear-gradient lift force is strongly dependent on the magnitude of the shear rate^{23,24}. The concave corner creates a shear rate asymmetry in which the shear rate along the SA is greater than that along the LA (FIGS. 4D-4E). In analogy with previous works describing inertial equilibrium positions in rectangular channels, this causes particles destabilized off of the LA to migrate in the +x direction under dominant shear-gradient lift force until they are directed towards the stable equilibrium point on the SA by dominant wall-induced lift forces. See, Liu, C., Hu, G., Jiang, X. & Sun, J. Inertial focusing of spherical particles in rectangular microchannels over a wide range of Reynolds numbers. Lab Chip 15, 1168-1177 (2015); and Gossett, D. R. et al. Inertial Manipulation and Transfer of Microparticles Across Laminar Fluid Streams. Small 8, 2757-2764 (2012). The origin of this asymmetry can be seen from the simulated velocity profiles shown in FIG. 4F, which shows the axial velocity of a fluid flowing in a particle-less channel with no-slip boundary conditions. The maximum axial velocity is located at the channel center, so the shear gradient will be greater along the SA relative to the LA because the distance from the channel center to the zero velocity wall is shorter.

From this analysis one can see that inertial forces in the equilateral cross and star channels will tend to direct particles to focusing positions along the axes between the channel center and concave corners because of the effect of concave corners on the velocity profile of the flow. The concave corner creates a strong shear gradient parallel to the SA and weak shear gradient parallel to the LA, which cause the concave corners to act as “particle attractors”. This principle should be translatable to different geometries, which, by leveraging the geometric tunability of the fiber microfluidic platform, could be fabricated to have inertial focusing positions tailored to the need of the particle manipulation applications.

### Multimaterial Functionality: DEP Cell Separation

Multimaterial functionality of the fiber platform can be demonstrated by introducing conductive materials onto microchannel surfaces to create a dielectrophoretic (DEP) cell separation device. DEP is an electrokinetic particle manipulation technique that describes the motion of polarized dielectric particles within a non-uniform electric field. Based on the polarizability of the particle relative to the media, particles will move to (pDEP) or away from (nDEP) regions of high electric field strength. DEP is a label-free and specific particle manipulation technique that has been studied for the characterization, separation, and trapping of bioparticles. See, Vahey, M. D. & Voldman, J. An Equilibrium Method for Continuous-Flow Cell Sorting Using Dielectrophoresis. Anal. Chem. 80, 3135-3143 (2008); Yang, J. et al. Dielectric properties of human leukocyte subpopulations determined by electrorotation as a cell separation criterion. Biophys. J. 76, 3307-3314 (1999); Moon, H.-S. et al. Continuous separation of breast cancer cells from blood samples using multi-orifice flow fractionation (MOFF) and dielectrophoresis (DEP). Lab Chip 11, 1118-1125 (2011); Shafiee, H., Sano, M. B., Henslee, E. a, Caldwell, J. L. & Davalos, R. V. Selective isolation of live/dead cells using contactless dielectrophoresis (cDEP). Lab Chip 10, 438-445 (2010); Alazzam, A., Stiharu, I., Bhat, R. & Meguerditchian, A. N. Interdigitated comb-like electrodes for continuous separation of malignant cells from blood using dielectrophoresis. Electrophoresis 32, 1327-1336 (2011); Wei, M. T., Junio, J. & Ou-Yang, D. H. Direct measurements of the frequency-dependent dielectrophoresis force. Biomicrofluidics 3, 1-9 (2009); Su, H.-W., Prieto, J. L. & Voldman, J. Rapid dielectrophoretic characterization of single cells using the dielectrophoretic spring. Lab Chip 13, 4109-17 (2013); Huang, Y., Holzel, R., Pethig, R. & Wang, X. B. Differences in the AC electrodynamics of viable and non-viable yeast cells determined through combined dielectrophoresis and electrorotation studies. Phys. Med. Biol. 37, 1499-517 (1992); and Cheng, I. F., Chang, H. C., Hou, D. & Chang, H. C. An integrated dielectrophoretic chip for continuous bioparticle filtering, focusing, sorting, trapping, and detecting. Biomicrofluidics 1, 1-15 (2007).

The DEP force on a particle is proportional to ∇|E|², so DEP microparticle manipulation devices require positioning of electrodes on the scale of 10 μm apart to allow for operation at practical voltages (˜10V). To date, the primary method of introducing conductive components into DEP devices has been through planar metal electrodes. See, Vahey, M. D. & Voldman, J. An Equilibrium Method for Continuous-Flow Cell Sorting Using Dielectrophoresis. Anal. Chem. 80, 3135-3143 (2008); Alshareef, M. et al. Separation of tumor cells with dielectrophoresis-based microfluidic chip. Biomicrofluidics 7, 11803 (2013); Markx, G. H. Separation of viable and non-viable yeast using dielectrophoresis. J. Biotechnol. 32, 29-37 (1994); and Becker, F. F. et al. Separation of human breast cancer cells from blood by differential dielectric affinity. Proc. Natl. Acad. Sci. U.S.A 92, 860-864 (1995). The fabrication process of planar metal electrodes typically involves metal deposition onto a substrate, photoresist patterning, etching, and bonding to a separate component that includes the microchannels. This multi-component method of device fabrication presents alignment challenges, as this process requires long-range (˜10 cm) alignment of elements with micron-scale features. The multimaterial functionality of the fiber microfluidics platform can also enable the fabrication of microchannels adjacent to closely-spaced electrodes that are typically utilized in DEP devices. Furthermore, in contrast to microfabricative techniques, the scale-down process is a one-step method that creates a fully integrated DEP microchannel without the need for additional alignment. To demonstrate this multimaterial functionality, a continuous two-electrode DEP bioparticle separation fiber was fabricated and characterized.

### DEP Fiber Design

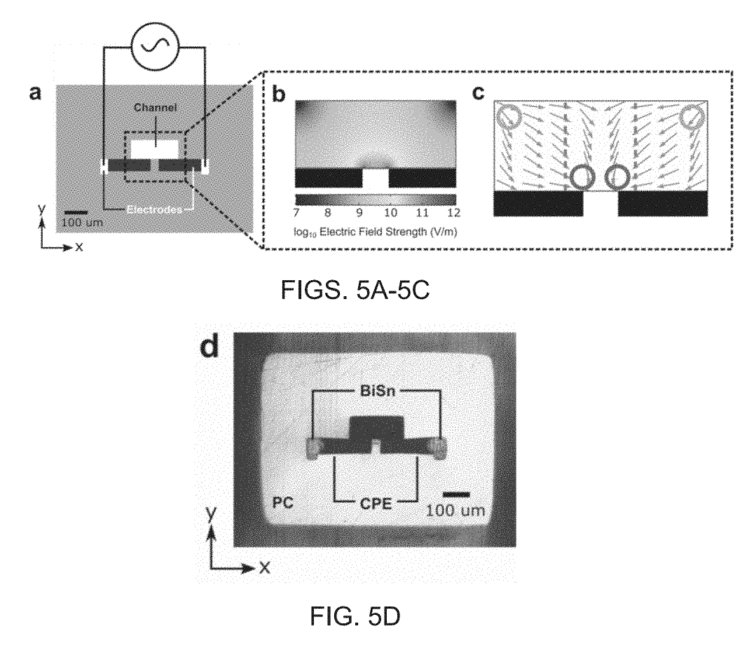

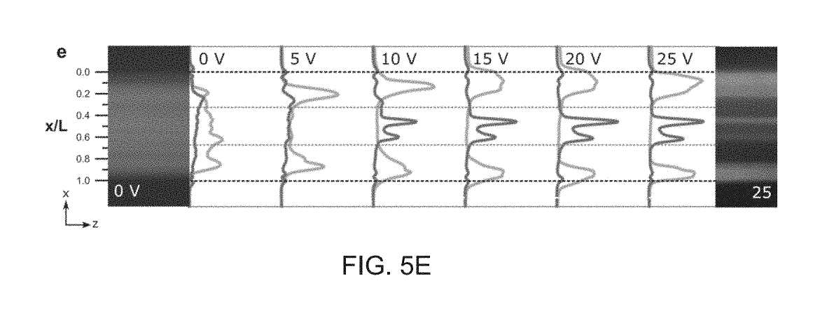

The dielectrophoretic cell separation fiber, hereby called the DEP fiber, was designed to spatially separate particles experiencing pDEP and nDEP to distinct locations along the channel cross-section. To generate a non-uniform electric field, two closely spaced (30 μm apart), coplanar electrodes were positioned along the interior wall of a 2.36:1 ratio rectangular channel of dimensions 200 μm by 85 μm (FIG. 5A).

FIG. 5B shows the distribution of the electric field strength in a logarithmic scale, which predicts a strong electric field at the tips of the electrodes where they are the shortest distance away from each other, and a weak electric field at the outer, upper corners of the channel. FIG. 5C shows an arrow plot of the direction of the electric field gradient within the channel, which is separated horizontally into thirds with pink lines. Particles that feel a pDEP force will focus to the center third of the channel (red circles), while particles that feel an nDEP force will focus to the outer two-thirds of the channel (green circles).

### Materials Selection

DEP particle manipulation devices function by applying a controlled electric field to particles in flow. Thus, DEP electrodes must be able to be placed in close proximity to the flow with spatial precision. The integrated conductive electrode materials chosen for this fiber design, carbon-loaded polyethylene (CPE) and a eutectic Bi—Sn alloy, were selected to address several design challenges.

Firstly, drawing adjacent low-viscosity domains (e.g., metal and air), leads to kinetic instabilities and dimensional fluctuation. See, Egusa, S. et al. Multimaterial piezoelectric fibres. Nat. Mater. 9, 643-648 (2010). Minimizing losses in insulators leads DEP devices have electrodes in direct contact with the flowing media. Thus, CPE was used, which has a high viscosity at the draw temperature, to serve as a conductor-fluid interface material at the interior microchannel surface. Because the CPE has a high electrical resistance relative to metals, the Bi—Sn alloy was placed adjacent to the CPE to minimize axial resistive losses. By completely surrounding the low viscosity Bi—Sn alloy with the high-viscosity cladding (PC) and CPE, kinetic break-up was avoided and low-resistance electrodes were achieved along the length of the fiber.

The second parameter that had to be considered was synchronous flow. Because the preform is heated and drawn as a single entity, its constituting materials must each have a low enough viscosity at the draw temperature to allow for steady dimensional reduction. A PC/CPE/Bi—Sn materials system was chosen because their material properties are thermally compatible. Furthermore, optically transparent polycarbonate was chosen as the fiber cladding material to facilitate visualization of the fiber channel. A cross-sectional image of a drawn DEP fiber is shown in FIG. 5D.

### In-Fiber Cell Separation

The in-fiber separation performance of the DEP fiber was observed using LEF along the x-z plane of the fiber. A cell and particle mixture of BA/F3 cells and 10 μm PS beads suspended in a low conductivity isoosmotic solution were flowed through a 10 cm long fiber at a rate of 30 L/min.

In FIG. 5E the positions of the BA/F3 cells (red) and PS beads (green) were shown within the fiber channel across different voltages at a frequency of 10 MHz. At this frequency and media conductivity, BA/F3 cells demonstrate pDEP behavior while PS beads demonstrate nDEP behavior, as expected.

In the absence of an applied field, there is no discernable focusing behavior of the cells or beads within the fiber cross-section. As predicted by simulation, in the presence of an applied field the BA/F3 cells focus to two points at the inner tips of the CPE electrodes and the PS beads focus to the channel edges (FIG. 5E). When the applied voltage is increased to 15 V, the BA/F3 cells are pushed into the center third of the channel, while the PS beads are partitioned to the outer thirds. Furthermore, particles have migrated to their equilibrium positions at 15 V, so further increases in voltage to do not measurably affect the final particle focusing positions.

### DEP Cell Separation Device

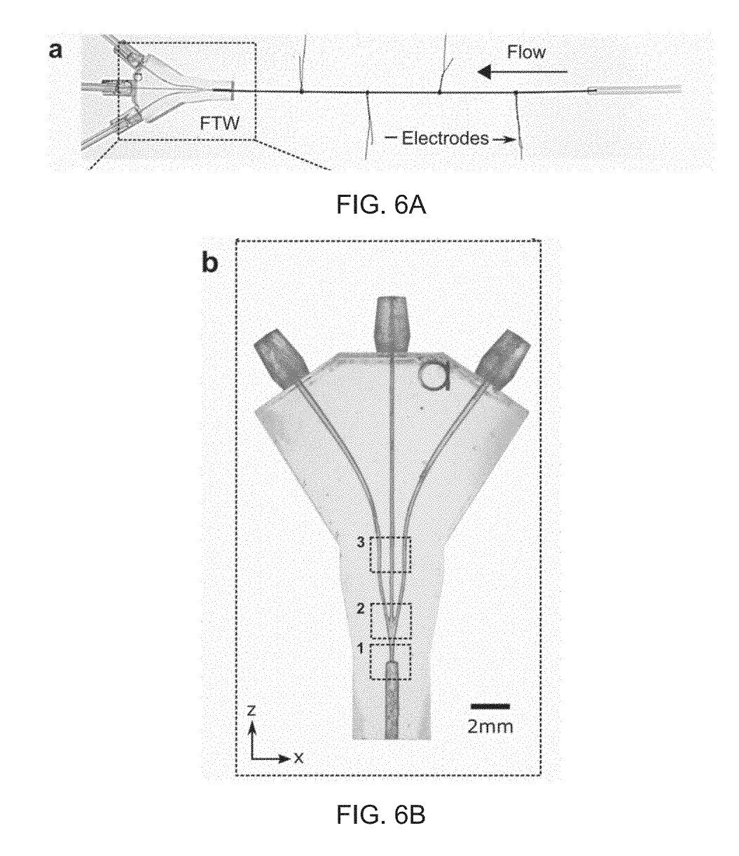

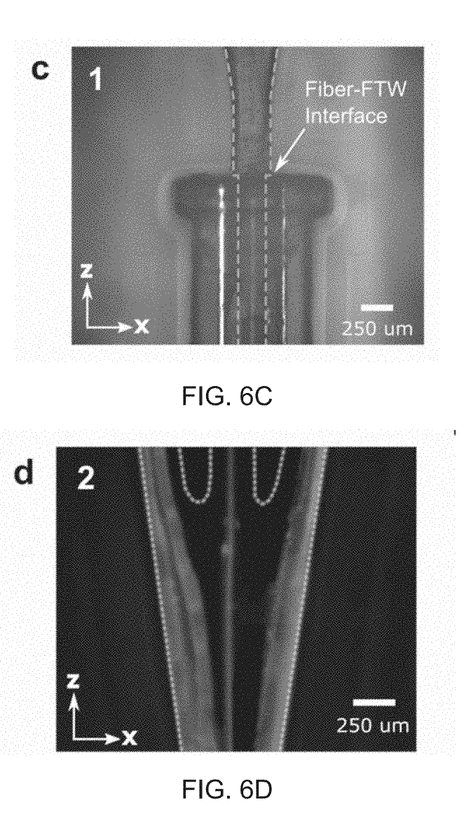

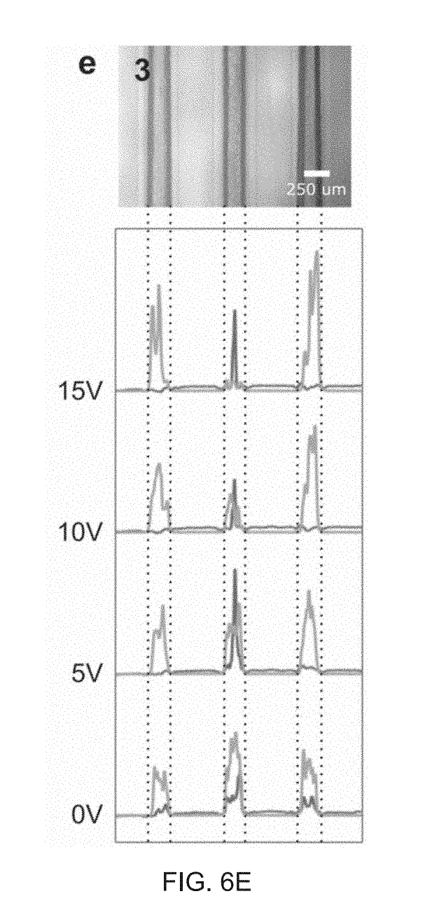

The DEP fiber was mated with a specifically designed FTW to create a complete cell separation device capable of physically separating the BA/F3 cells and PS beads at the device outlet (FIG. 6A). The FTW was 3D-printed using a clear resin to allow for optical visualization of the channel interior. The FTW consists of three sections: 1) A self-aligning mating port (FIG. 6B, Box 1), 2) a stream splitting trifurcation fork (FIG. 6B, Box 2), and 3) a parallel channel section to allow for quantitation of the particle separation (FIG. 6B, Box 3).

The self-aligning mating port is a two-section rectangular channel (FIG. 6C). The channel dimensions of the bottom section of the mating port match the outer dimensions of the DEP fiber (850 μm×635 μm) and the top section consists of a rectangular channel (250 μm×150 μm) that is slightly larger than the channel in the DEP fiber (200 μm×85 μm). When the DEP fiber is slotted into the bottom section of the mating port, the center of the top section of the mating channel aligns with the center of the fiber channel. The blue lines in FIG. 6C show the locations of the interior channel walls from the fiber into the FTW. Although there is a small step-change in channel dimension at the fiber-FTW interface, smooth streamlines were maintained at this transitionary region during device operation.

A cell and particle mixture of BA/F3 cells and 10 μm PS beads suspended in a low conductivity isoosmotic solution was flowed through a 10-cm-long DEP cell separation device at a rate of 30 μL/min. Particle behavior was observed across different voltages at a frequency of 10 MHz. Under an applied field, time-averaged LEF streak images in FIG. 6D show that the spatial separation of the BA/F3 cells (red) and PS (green) beads induced within the fiber is maintained through the stream splitting trifurcation fork. Thus, BA/F3 cells are physically isolated to the center of the trifurcation fork, while PS beads are guided to the outer prongs.

FIG. 6E shows the particle distribution within the parallel channel section of the FTW chip across a range of applied voltages. In the absence of an applied voltage, both BA/F3 cells and PS beads are found to be randomly distributed across all three outlets. As the applied voltage is increased, and therefore the magnitude of the DEP force as well, BA/F3 cells are increasingly focused towards the center outlet while PS beads are pushed towards the outer two outlets.

### Discussion

Fiber microfluidics, a new, fiber-based platform for fabricating microfluidic devices has been introduced. First, the cross-sectional geometric tunability of the fiber microfluidics platform has been utilized to study unexplored regimes in inertial microfluidics by fabricating microchannels with complex features that are inaccessible using traditional microfabrication techniques. Channels with concave geometric features have been demonstrated to tend to focus particles to positions adjacent to the concave corners because of a high shear-gradient force induced by the no-slip boundary condition at the corner wall. Furthermore, the transverse forces governing the positions of the particle focusing locations are predictable by solving Navier-Stokes equations using numerical simulation software. While current inertial microfluidics devices are limited to simple geometries, such as rectangles, semi-circles, and triangles, the agreement between theory and experiment demonstrated in this study could enable “velocity sculpting”, in which custom tailoring of inertial equilibrium positions by modification of channel geometry enables future exploration of inertial microfluidic physics and next generation particle separation devices.

Second, the multimaterial functionality of the fiber microfluidics platform has been demonstrated by incorporating conductive materials onto the channel surface of a DEP cell separation device. In-fiber spatial separation of BA/F3 cells and polystyrene beads was shown as well as physical separation at the device outlet using a 3D printed FTW mating chip that is able to split flow streams out of the fiber without disturbing laminar flow. The complete DEP cell separation device operated at a flow rate of 30 μL/min, which is around an order of magnitude higher than the typical flow rate of DEP cell separation devices. By adjusting the channel size, channel geometry, electrode placement and fiber length, the flow rate of DEP cell separation devices could be further increased.

Due to the high impedance of the CPE incorporated into the DEP fiber (Supplementary), DEP experiments in this study were limited to samples in low conductivity media because of the adverse effects of Joule heating and axial voltage decay. This challenge could be overcome by designing and drawing fibers with metal-only electrodes.

The fiber microfluidics platform can be capable of fabricating devices that can manipulate particles using both active (DEP) and passive (inertial) forces that act on the particles in a direction transverse to the fluid flow. Many other methods for cell separation and sorting, such as Dean flow or acoustophoresis, being studied for next generation cell separation devices are prime candidates to be adapted to the fiber microfluidics platform by leveraging its cross-sectional geometric tunability and multimaterial functionality. Furthermore, incorporating several different modes of cell separation into a single fiber will enable a high degree of design freedom to be engineered into a single device for specific tailoring of the transverse force profile. The high degree of design freedom enabled by multimodal particle separation fibers could potentially be used to engineer high throughput cell separation devices for the isolation of rare cells (CTC, CFC) and ultrafast analysis.

Ultimately, a future is envisioned in which the unique capabilities of the fiber microfluidic platform make it a common tool, alongside existing methods such as microfabrication, 3-D printing, and paper microfluidics, for microfluidic device engineers to optimally address their application needs.

### Experimental

### Equilateral Cross and Star Channel Fabrication.

To fabricate the equilateral cross fiber, cross-shaped grooves were machined into two slabs of polycarbonate (PC; McMaster-Carr) and annealed at 180° C. in a hot press with a Teflon (McMaster-Carr) insert machined into the shape of a cross slotted inside.

To fabricate the star fiber, wire electrical discharge machining (wire EDM) was used to fabricate an aluminum rod with a star-shaped cross section (XACT Wire EDM Corporation). The star-shaped aluminum rod was coated with a spray-on and heat-cured Teflon coating (Durafilm Teflon Black; applied by American Durafilm Co. Inc.). Rectangular grooves were machined into two slabs of PC (McMaster-Carr) and annealed in a vacuum oven at 200° C. with the star rod slotted into the grooves until the PC completely molded into the shape of the rod.

For both preforms, the inserts were then removed, and the preform was drawn using the thermal fiber drawing technique at 240° C. Fluidic connections to the fibers were made by inserting them into 0.004″ inner diameter PEEK™ tubing (IDEX Health and Science) and sealing with epoxy.

### DEP Fiber Fabrication.

To fabricate the DEP Fiber, rectangular grooves were machined into two PC (McMaster-Carr) slabs and the corresponding pieces of conductive polyethylene (CPE; Hillas Packaging) and 58-42 BiSn alloy (Indium Corporation) were slotted into them. The section of the preform corresponding to the channel was filled with a corresponding Teflon (McMaster-Carr) insert. A 25 μm layer of PC film was at the CPE-channel interface to prevent leakage of the CPE into the channel during annealing. The preform was annealed in a hot press at 175° C. and drawn using the thermal drawing process at 240° C.

Electrodes were connected to the fiber by mechanically exposing the electrode of the fiber at the desired position and connecting it to an external wire using conductive silver paint (Ted Pella Inc.). Fluidic connections were made in the same manner as the inertial focusing fibers.

### DEP Cell Separation Device Fabrication and Operation.

The FTW chip was designed in a CAD program (Solidworks) and printed with 50 μm layer thickness using a stereolithographic 3D printer (Projet 6000 HD, 3D Systems) with a clear resin (Visijet SL Clear). Support structure placement during the print was set such that there were no support structures within the chip channels. Uncured resin within the channels of the FTW were mechanically removed using thin wires.

To prevent hydrolysis at the fiber tip during device operation, a thin layer of epoxy was applied to the fiber tip without blocking fluid flow out of the outlet. The DEP fiber was mated to the FTW using epoxy. The channels were primed with a BSA solution (lx PBS/3% BSA) at a flow rate of 50 μL/min for 30 min.

To control the flow rates out of each outlet of the FTW, two of the outlet ports of the FTW were connected to syringe pumps that withdrew fluid at a controlled flow rate of 10 μL/min. Because the inlet flow rate of the device was 30 μL/min, this set all three outlet flow rates to 10 μL/min.

### PS Bead Preparation.

10 μm green fluorescent (excitation 441 nm, emission 486 nm) polystyrene particles (density 1.05 g cm⁻³) with carboxylate surface groups (Polysciences, Inc) were used for all experiments. The particles were dispersed in DI water until they reached a particle concentration of 1 million particles/mL. The flow rates of experiments were rapid enough such that additional reagents did not need to be added to prevent particle sedimentation.

### Ba/F3 Preparation.

BA/F3 cells were centrifuged and stained with a 1 μM Calcein Red/Orange (CellTrace™, Life Technologies) PBS solution. The stained cells were recentrifuged and resuspended in a low conductivity media (8.5 wt % Sucrose, 0.3 wt % Dextrose) to a concentration of ˜1 million cells/mL and flowed through a 35 μm syringe filter (BD Biosciences) to remove cell debris.

### Long Exposure Fluorescence Microscopy (LEF).

Fiber samples were mounted to a glass slide on one face and a glass slide on the opposite face using epoxy. Flow was delivered to the fibers using a syringe pump (Fusion 200; Chemyx) using syringes connected to the fiber-interfacing tubing. Particles were observed through the glass cover slip using an optical microscope (Zeiss AXIO), a CCD camera (Imager QE, LaVision), and fluorescence light source (X-Cite 120; EXFO). Particles were observed at a distance of 5 cm ahead of the input end of the fiber to ensure that they were in their steady-state configuration.

Histograms of particle distributions were obtained by recording videos of particle flow with 100-200 μs exposure times. These recorded videos were processed via MATLAB frame by frame. Background images were obtained through a time-averaged domain median filter. The background images were subtracted from each frame and the total intensity of 1 pixel thick lines was averaged over the entire recording to obtain the final particle distribution histogram.

### Cross-Section Imaging.

To image both the inertial focusing fibers and the DEP fiber, the fibers were fixed in an epoxy matrix and mechanically polished using increasingly fine grades of sandpaper and a finishing 1 μm alumina particle solution until the total thickness of the epoxy was around 20 mm. The samples were imaged using an optical microscope in transmission mode (Axioskop 2, Carl Zeiss MicroImaging Inc.).

### Confocal Imaging.

Fiber samples were mounted to a glass slide using epoxy. Flow was directed into the fibers in the same manner as the LEF experiments. To prevent image distortion from rough fiber surfaces or index mismatch, the fibers were observed through immersion oil (n=1.515, Olympus Corporation). Confocal imaging on the inertial focusing fibers was performed by using a confocal laser scanning microscope (FluoView™ FV1000, Olympus Corporation) to scan a 3-dimensional section of the fiber channel with an exposure time of 200 μs/pixel. Particle distributions were obtained by taking the projection of the 3-dimensional section onto the x-y plane.

### Numerical Simulation of Inertial Forces.

The inertial force profile of the equilateral cross and star shaped channels were modelled by using COMSOL Multiphysics to solve for the transverse forces on a spherical and rotating wall (diameter a=10 μm) that is translationally stationary within a geometric channel with walls moving backwards at the average fluid velocity. The initial inlet and outlet boundary conditions were set to be fully developed laminar flow. The axial length of the channel was set to be three times the length of the largest cross-sectional dimension. To determine the behavior of particle at a single x-y coordinate, the complete 3-D Navier-Stokes equations were solved for and values for the particle angular velocity and particle velocity iteratively updated until both the dimensionless torque (∫∫_{Area}σ·r/ρU_{avg}²a³) and dimensionless axial force (∫∫_{Area}σ_{z}/ρU_{avg}²a²), where U_{avg} flow and is the average velocity of the and σ is stress, on the particle were less than 10⁻⁶. The transverse inertial forces were solved by integrating the total force per area in the transverse directions across the particle surface. The complete force profile was obtained by repeating this iterative process for the particle at many x-y positions.

Laminar velocity profiles were modelled by solving the complete 3-D Navier-Stokes equations for each channel using no-slip boundary conditions. The z-component of fluid velocity for the LA and SA cut lines were exported into MATLAB. The shear gradient plot was obtained by fitting the velocity data to a 9^{th} order polynomial function and taking the second derivative with respect to arc length. The modelled flow rate for the equilateral cross channel was 100 μL/min (Re=32) and for the star-shaped channel was 200 μL/min (Re=60).

### Numerical Simulation of DEP Forces:

The electric field distribution within the fiber channel using a commercial FEM software package (COMSOL Multiphysics 5.2, Comsol Inc.) was modeled by solving Laplace's equation with the electric current module under an applied voltage of 25 V.

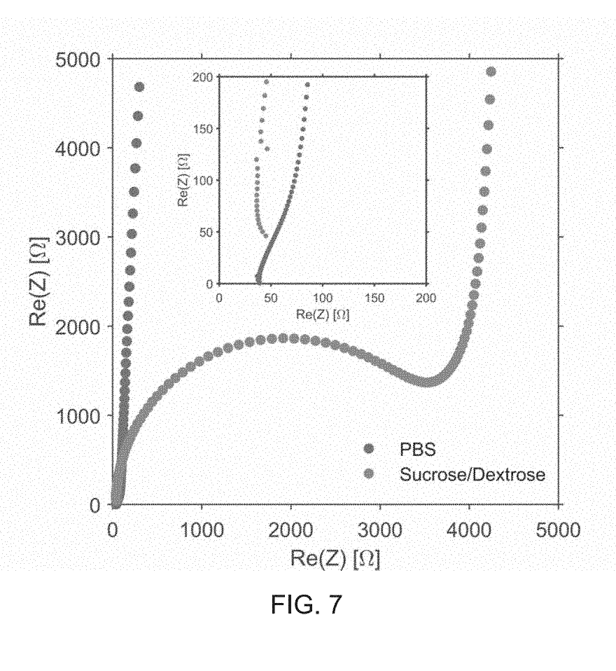

In FIG. 7, impedance ranges of 0-5000Ω and 0-200Ω (inset) is shown. Impedance profiles for 7.8 cm long sections of the DEP fiber filled with PBS and a low conductivity media (8.5 wt % sucrose, 0.3 wt % dextrose solution) were recorded. The impedance profiles resemble that of a Randle's cell equivalent circuit. The expected resistance for each CPE-BiSn electrode using material constants, was 44Ω, while the solution resistance for the PBS and low conductivity media were 20Ω and 3200Ω, respectively. These calculated values are consistent with the measured data. Thus at high solution conductivities, there is a high voltage drop through the resistive electrodes that negatively affects the effectiveness of DEP particle manipulation (i.e. Joule heating).

Each of the references cited herein is incorporated by reference in its entirety.

Other embodiments are within the scope of the following claims.

What is claimed is:

1. A particle separation device comprising:
a fiber microfluidic structure,
a fluid input, and
an outlet.

2. The particle separation device of claim 1, wherein the fiber microfluidic structure has at least one concave feature in a cross-section of the structure.

3. The particle separation device of claim 1, wherein the fiber microfluidic structure has a length that is at least three times the width of a channel of the structure.

4. The particle separation device of claim 1, wherein the outlet includes a plurality of fluid outlets.

5. The particle separation device of claim 1, wherein the structure includes electrodes arranged to apply a voltage across a width of the fiber structure.

6. A method of manufacturing a fiber microfluidic structure comprising:
drawing a preform into a fiber, the fiber having a channel with a cross-section of a preselected shape.

7. The method of claim 6, wherein the fiber microfluidic structure has at least one concave feature in a cross-section of the structure.

8. The method of claim 6, wherein the fiber microfluidic structure has a length that is at least three times the width of the channel.

9. The method of claim 6, wherein the outlet includes a plurality of fluid outlets.

10. A method of cell separation comprising:
passing fluid containing a plurality of cells through a fiber microfluidic structure, and
collecting a plurality of outputs from an opening of the fiber microfluidic structure.

11. The method of claim 10, wherein the fiber microfluidic structure has at least one concave feature in a cross-section of the structure.

12. The method of claim 10, wherein the fiber microfluidic structure has a length that is at least three times the width of the channel.

13. The method of claim 10, wherein the outlet includes a plurality of fluid outlets.

14. The method of claim 10, further comprising applying a voltage across a width of the fiber structure.
